(19) United States
(12) Patent Application Publication
(10) Pub. No.: US 2024/0334291 A1
(43) Pub. Date: Oct. 3, 2024

(54) DUAL CONNECTIVITY MASTER NODE HANDOVER FAILURE RECOVERY VIA TARGET SECONDARY NODE FOR WIRELESS NETWORKS

(71) Applicant: Nokia Technologies Oy, Espoo (FI)

(72) Inventors: Subramanya CHANDRASHEKAR, Bangalore (IN); Srinivasan SELVAGANAPATHY, Bangalore (IN); Ahmad AWADA, Munich (DE); Amaanat ALI, Espoo (FI); Faranaz SABOURI-SICHANI, Aalborg (DK)

(21) Appl. No.: 18/580,027

(22) PCT Filed: Jul. 4, 2022
(86) PCT No.: PCT/EP2022/068391

§ 371 Date: Jan. 17, 2024

(30) Foreign Application Priority Data
Jul. 19, 2021 (IN) 202141032412

(51) Int. Cl. H04W 36/30; H04W 36/00; H04W 74/00

(52) U.S. Cl. CPC H04W 36/305; H04W 36/00692; H04W 74/004

(57) ABSTRACT

A method includes receiving (610), by a user device that has been configured for dual connectivity, preconfiguration information including information indicating a signaling radio bearer for a second network node to enable the user device to report failure of a first random access procedure between the user device and a first network node, via a second random access procedure with the second network node regardless of whether a connection has been established between the user device and the first network node: transmitting (640), by the user device to the second network node via the indicated signaling radio bearer, a radio link failure report indicating a failure of the first random access procedure with the first network node; and receiving (650) a message indicating an action to be performed by the user device in response to the failure of the first random access procedure.

### PRIORITY CLAIM

This application claims priority to Indian Patent application No. 202141032412, filed on Jul. 19, 2021, entitled “DUAL CONNECTIVITY MASTER NODE HANDOVER FAILURE RECOVERY VIA TARGET SECONDARY NODE FOR WIRELESS NETWORKS,” the entirety of which is hereby incorporated by reference.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include: receiving, by a user device that has been configured for dual connectivity, preconfiguration information including information indicating a signaling radio bearer for a second network node to enable the user device to report failure of a first random access procedure between the user device and a first network node via a second random access procedure with the second network node regardless of whether a connection has been established between the user device and the first network node; initiating, by the user device, a first random access procedure with the first network node; detecting, by the user device, a failure of the first random access procedure with the first network node; transmitting, by the user device to the second network node via the indicated signaling radio bearer, a radio link failure report indicating the failure of the first random access procedure with the first network node; and receiving, by the user device from the second network node, a message indicating an action to be performed by the user device in response to the failure of the first random access procedure with the first network node.

According to an example embodiment, a method may include: receiving, by a second network node configured as a secondary node from a first network node configured as a master node as part of a dual connectivity for a user device, information requesting the second network node to prepare resources including at least a partially activated signaling radio bearer to enable the user device to communicate to the second network node a radio link failure report to report a failure of a first random access procedure between the user device and the first network node via the partially activated signaling radio bearer and a second random access procedure of the user device with the second network node, regardless of whether a connection has been established between the user device and the first network node; partially activating, by the second network node, a signaling radio bearer to receive a radio link failure report via the second random access procedure with the user device, regardless of whether a connection has been established between the user device and the first network node; transmitting, by the second network node to be delivered to the user device, preconfiguration information including at least the signaling radio bearer configuration for the partially activated signaling radio bearer; and receiving, by the second network node from the user device, via the partially activated signaling radio bearer, a radio link failure report indicating the failure of the first random access procedure with the first network node.

According to an example embodiment, a method may include: transmitting, by a first network node configured as a master node to a second network node configured as a secondary node as part of a dual connectivity for a user device, information requesting the second network node to prepare resources including at least a partially activated signaling radio bearer to enable the user device to communicate to the second network node a radio link failure report to report a failure of a first random access procedure between the user device and the first network node via the partially activated signaling radio bearer and a second random access procedure of the user device with the second network node, regardless of whether a connection has been established between the user device and the first network node; receiving, by the first network node from the second network node, a radio link failure report originating from the user device and indicating the failure of the first random access procedure between the user device and the first network node; transmitting, by the first network node to the second network node for forwarding to the user device, a message indicating an action to be performed by the user device in response to the failure of the first random access procedure with the first network node.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating a 4-step contention based random access (CBRA) procedure.

FIG. 3 is a diagram illustrating a wireless network according to an example embodiment.

FIG. 4 is a diagram illustrating operation of a network according to an example embodiment.

FIG. 5 is a diagram illustrating operation of a network according to another example embodiment.

FIG. 6 is flow chart illustrating operation of a user device (or UE) according to an example embodiment.

FIG. 7 is a flow chart illustrating operation of a network node (e.g., such as a target secondary node) according to an example embodiment.

FIG. 8 is a flow chart illustrating operation of a network node (e.g., such as a target master node) according to an example embodiment.

FIG. 9 is a block diagram of a wireless station or node (e.g., AP, BS, RAN node, DU, UE or user device, or network node).

### DETAILED DESCRIPTION

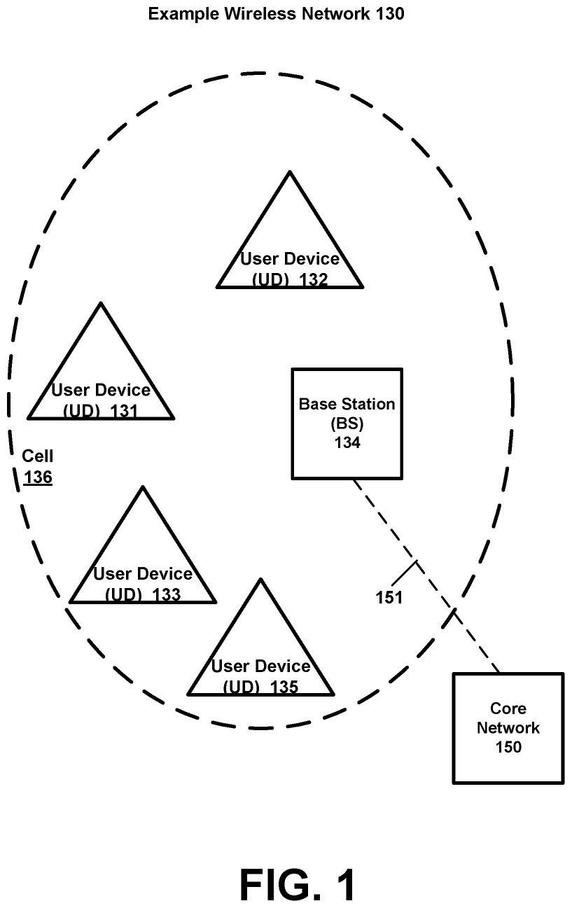

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a SI interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, IoT, MTC, eMTC, eMBB, URLLC, etc., or any other wireless network or wireless technology. These example networks, technologies or data service types are provided only as illustrative examples.

According to an example embodiment, a random access channel (RACH) procedure or random access procedure may be performed by a UE or user device for a variety of reasons (or triggers). For example, a UE may use a random access procedure to establish a connection with a network node (e.g., BS, AP, eNB, gNB). Random access procedures may have the possibility of failure, e.g., due to collisions or other reasons. A random access procedure may be contention based (a contention based random access (CBRA) procedure) or contention free (a contention free random access (CFRA) procedure). In addition, there are two types of random access procedures, namely a 4-step random access procedure, and a 2-step random access procedure.

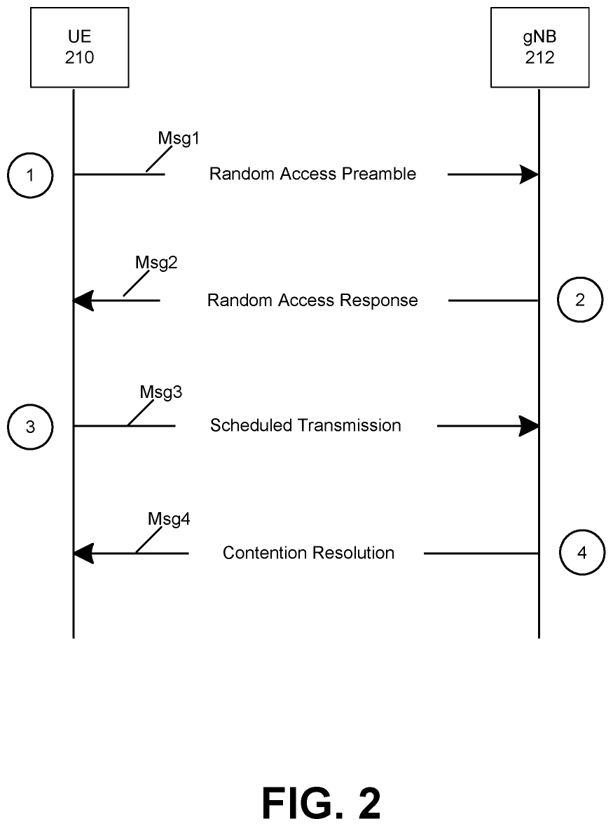

FIG. 2 is a diagram illustrating a 4-step contention based random access (CBRA) procedure between a UE 210 and a gNB 212. In a 4-step CBRA procedure, the UE 210 starts the random access procedure at step 1 by sending a random access preamble (message 1 or Msg1) to the gNB 212. There may be different groups of RACH preambles defined, depending on the size of the first scheduled uplink transmission from the UE 210 and on the UE's channel conditions. The UE 210 may obtain information on how to access the network from system information block 1 (SIB1), which are part of the system information (SI) that is transmitted (e.g., broadcasted or signalled) by the gNB 212. The RACH preamble may be designed for relatively low complexity and high robustness (and thus, enhanced likelihood of reception by the gNB 212) despite a lack of accurate timing control. If the gNB 212 receives the random access preamble successfully, the gNB 212 responds at step 2 with a Random Access Response (RAR or message 2 or Msg2). The RAR may include a random access preamble identifier (RAPID) that identifies the received RACH preamble, an uplink timing advance (TA) for the UE 210 (e.g., calculated by the gNB 212 based on the received RACH preamble from the UE 210), a temporary identity, e.g., such as a cell-radio network temporary identifier (C-RNTI), assigned to the UE 210, and an uplink (UL) grant indicating physical uplink shared channel (PUSCH) resources to be used for UE 210's subsequent transmission. At step 3, upon receiving the RAR, the UE 210 is able to send a scheduled transmission to the gNB 212 (message 3 or Msg3) via the scheduled PUSCH resources indicated in the UL grant of the RAR. At step 4, if the gNB 212 receives the scheduled transmission via PUSCH, the gNB 212 sends a contention resolution message (message 4 or Msg4) to indicate whether the scheduled transmission by the UE 210 was successful and to ensure that the UE 210 does not incorrectly use another UE's identity.

A 2-step random access (e.g., CBRA) procedure was introduced to reduce the number of round-trip transmissions between the UE and the gNB (and thus reduce the amount of latency) until the RACH procedure is successful, namely from 2 round-trip transmissions to 1 round trip transmission. The 2-step random access procedure reduces the number of round-trip transmissions by combining both message 1 and message 3 (Msg1 and Msg3) of the 4-step random access procedure into a new message called message A or MsgA, and by further combining both message 2 and message 4 (Msg2 and Msg4) of the 4-step random access procedure into a new message called message B or MsgB. Due to its property of minimizing RACH channel occupancy until successful RACH access, 2-step RACH procedure has been considered for unlicensed access, since this procedure may reduce the amount of Listen Before Talk (LBT) attempts, and thereby increase the probability of successfully completing the RACH procedure. However, there may be a higher likelihood of failure for a 2-step random access procedure as compared to a 4-step random access procedure.

In addition to 2-step and 4-step contention based random access (CBRA) procedures, 2-step and 4-step contention free random access (CFRA) procedures may also be supported. For example, for the 4-step CFRA procedure, the gNB may first provide the UE with a random access preamble assignment for Msg1 transmission. For the 2-step CFRA procedure, the gNB may provide the UE with both a random access preamble assignment and PUSCH assignment (UL grant that identifies PUSCH resources for UE uplink transmission) for MsgA transmission.

In dual-connectivity (or more generally referred to as multi-connectivity), a UE (or user device) may be connected to multiple base stations or network nodes simultaneously, where the network nodes may be of the same or different radio access technologies (RATs). Thus, for multi-connectivity, each of the network nodes may be an eNB, gNB, or other network node. For example, one of the network nodes may be referred to as a master node (MN) or master network node (e.g., master gNB (MgNB) or master eNB (MeNB)), while another network node may be referred to as a secondary node (SN) or a secondary network node (e.g., a secondary gNB (SgNB) or secondary eNB (SeNB)), e.g, with respect to the classical BS architecture. For dual or multi-connectivity, the UE may, for example, establish a first connection to a MN, and then establish a second connection to a SN. For each of the network nodes (MN or SN) that the UE is connected to, the UE may be able to communicate and/or receive data via multiple (a plurality of) cells, e.g., using carrier aggregation (CA). The cells of the MN may be referred to as a master cell group (MCG), while the cells of a SN may be referred to as a secondary cell group (SCG).

In the case of dual or multi-connectivity, the first cell within the MN to which the UE connects is typically known as the Primary Cell (PCell), while the first cell within the SN to which the UE connects is typically known as the Primary Secondary Cell (PScell), which serves as a primary cell as far as the UE's connectivity to the SN is concerned. The PCell and the PSCell are each allocated physical uplink control channel (PUCCH) resources to allow the UE to send HARQ ACK/NAK (acknowledgement/negative acknowledgement) feedback, and other control information, to the MCG (or MN) and SCG (or SN), respectively.

Handover (HO) (or cell change) procedures may be used in 5G NR to allow a change or handover of the UE from a source network node to a target network node, e.g., to maintain robustness of connection between a user equipment (UE) and a wireless network over different cells. A UE handover (HO) may be performed for a UE for both MN and SN, e.g., based on measurement reports and/or a HO trigger condition being satisfied.

For example, with respect to a UE connected to only one network node (single connectivity, or with respect to a MN HO for dual connectivity for the UE), to effect a HO, a UE sends measurement reports to a source network node indicating measurement values for serving and neighboring cells such as reference signal received power (RSRP). The measurement report is typically sent in an event-triggered manner when the measurement values meet certain criteria (e.g., the RSRP of neighboring cell becomes better than the measurement of the serving cell by some offset for some Time-to-Trigger (TTT)). Upon receiving the measurement report, the source network node (e.g., source gNB) identifies a target network node (a target gNB) to which the source gNB sends a HO request. The target gNB may acknowledge the HO request by sending an acknowledgement message to the source gNB. In response, the source gNB then sends a radio resource control (RRC) reconfiguration message to the UE, indicating a HO to the target gNB; at this point, data exchange between the UE and the source gNB terminates and the source gNB forwards data intended for the UE to the target gNB. The UE then initiates communication with the target gNB. For example, the UE sends a physical random access channel (PRACH) preamble to the target gNB. In response, the target gNB sends the UE a random access response (RAR), and the UE sends to the target gNB a message indicating that the RRC reconfiguration is complete. The target gNB sends the forwarded data to the UE and the connection between the UE and target gNB is established.

Alternatively, conditional HO (CHO) has been introduced to reduce radio link and HO failures. In CHO, a configured event triggers the UE to send a measurement report. Based on this report, the source gNB can prepare one or more target cells for the handover (CHO Request+CHO Request Acknowledge) and then sends an RRC Reconfiguration (including handover command) to the UE. In the baseline HO described above, the UE will immediately access the target cell to complete the handover. In contrast, for CHO, the UE will only access the target cell once an additional CHO execution condition is met (the handover preparation and execution phases are decoupled). The CHO execution condition may be configured, e.g., by the source network node in RRC Reconfiguration.

For a UE configured for dual connectivity (where the UE is connected to both a master node (MN) and a secondary node (SN)), with respect to the MN, a conditional handover may be prepared for the MN to allow the UE to perform a conditional handover from a source MN to a target MN when the CHO execution condition is met. Likewise, with respect to the SN, a Conditional PSCell Change (CPC) may be configured to allow the UE to perform a conditional handover or conditional PSCell change from a source SN to a target SN when the CHO/CPC execution condition is met for the target SN.

A UE may perform a handover to one or both of a target SN and/or target MN. However, currently, a UE is required to first have a connection established with a target MN before the handover or RACH procedure can be performed to a target SN. Thus, currently, if a connection (RACH success) to a target MN (e.g., PCell of MCG) has not been performed, UE attempts at RACH (random access procedure) access to a target SN/target SCG (PSCell) is not permitted because PCell RACH success is currently a prerequisite for performing a random access procedure with a SN/SCG. Even if the UE implementation performs such an attempt, currently, the target SN will not respond to RACH access for at least for the uplink packet unless the target SN receives a confirmation from the MN/MCG that a connection has been established between the UE and the MN/MCG (e.g., such as, for example, via receipt of a SGNB-Reconfiguration-complete or S-Node Reconfiguration Complete message from the target MN which is meant to activate the target SCG configuration for the UE at the target SCG/target SN). Currently, no resources (such as time-frequency resources and/or signaling radio bearer) are even allocated at target SN to allow UE transmission of a RACH Msg1 or Msg3 (for example) to the target SN until the target SN receives such a confirmation from the target MN/MCG that a connection has been established (e.g., successful RACH) by the UE with the MN/MCG. If the target MCG PCell access fails for the UE (e.g., radio link failure, RACH failure, HO failure for UE with respect to the target MN/MCG) (e.g., such as from a T304 timer Expiry, or other cause), there is no way for the UE to communicate with the network at that point, since the UE is also unable to communicate with the target SN (RACH messages from UE will be rejected by target SN because no confirmation of a successful UE-target MN connection has been received by target SN). Therefore, currently, in case of a MN radio link failure for a UE (e.g., radio link failure, RACH failure, HO failure), the only solution or response is for a RRC Re-establishment (re-establishing of the connection with a MN via new RACH procedure with a same or different MN), and no communication is permitted to the target SN, and which is expensive considering the re-establishment of bearers that will be required and the delay or service interruption time that will typically be experienced by the UE.

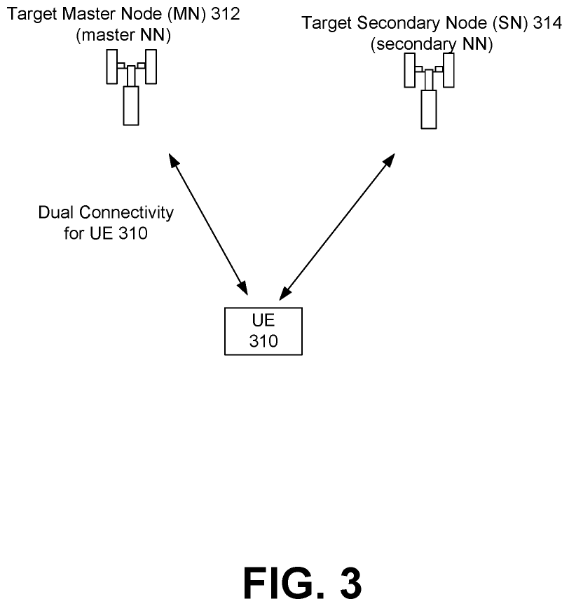

FIG. 3 is a diagram illustrating a wireless network according to an example embodiment. A UE 310 may be configured for dual connectivity, in which the UE 310 may be connected (or configured for connection) to multiple network nodes (e.g., multiple gNBs or DUs). Network nodes (e.g., gNBs) 312 and 314 are shown in FIG. 3 as examples. In this example, UE 310 may be attempting a first random access (RACH) procedure with (e.g., to establish a connection with, or perform a handover to) a target MN 312, and attempting a second RACH procedure (either in parallel with the first RACH procedure, or serially after attempting or performing the first RACH procedure) with a target SN 314 (to establish a connection with or perform a HO to the target SN 314). However, in some cases, the first RACH procedure may fail with the target MN 312. Currently, there is no way for the UE to perform a RACH procedure to a target SN or otherwise communicate with the network until a connection has been established between the UE 310 and the target MN 312 (e.g., until a RACH procedure between the UE and target MN 312 has been successful). Thus, as noted, currently, the UE may only attempt to re-establish a new connection to a target MN, which can be expensive in terms of latency (or connection interruption) and a new set of signaling radio bearer (SRB) and data radio bearer (DRB) that will be established for such a new connection.

According to an example embodiment, while a RACH with a target MN 312 may have failed, the UE 310 may still be permitted to communicate with the target SN 314. Therefore, according to an example embodiment, resources at a target secondary node (SN) 314 are provided (preconfigured) to allow UE 310 to send to the target SN 314 a radio link failure report to report a failure of the first random access (RACH) procedure with the target MN 312 via a message sent as part of the second random access procedure with the target SN 314, regardless of whether the UE 310 has received a confirmation that a connection has been established between the UE and the target MN 312. Thus, for example, resources are provided at the target SN 314 to allow the UE 310 to report the UE-target MN radio link failure to the target SN 314, regardless whether a connection has been established with the target MN 312 (in this case, there is no connection with the target MN 312, since the first RACH with target MN 312 has failed). Therefore, in this case, even though a connection is not currently established by UE 310 with the target MN 312, the UE 310 is still permitted, e.g., as part of a second RACH procedure with the target SN 314, to report to the target SN 314 the detected radio link failure (e.g., RACH failure, or HO failure) of the UE-target MN radio link (e.g., report failure of the first RACH procedure with target MN 312). This may allow the UE 310 to: 1) report to target SN 314, via the allocated resources, a radio link failure (or failure of the first RACH procedure) with target MN 312; and 2) a reply message to be sent to the UE (e.g., via the target SN 314) indicating an action to be performed by the UE in response to the failure of the UE-target MN radio link (or failure of the first RACH procedure), even though no connection is established yet between the UE and the target MN 312.

For example, the preconfiguration of resources by target SN 314 may include providing the UE with information indicating, e.g., one or more of: time-frequency resources for uplink communication, a partially activated signaling radio bearer (SRB) (such as a SRB3 or split-SRB1), and/or a RACH preamble for contention free RACH procedure with target SN 314 for the second RACH procedure with target SN 314, even though the target SN 314 may not have received a confirmation that a connection is established between UE and target MN 312. For example, in some cases, the partial activation of a signaling radio bearer (e.g., SRB3 or split-SRB1, for target SN 314) may be considered a partial activation because at least one of: 1) the SRB is activated or provided (e.g., only or primarily) for the purpose of sending one or more RACH messages to target SN 314, such as to allow UE 310 to send a radio link failure report to the target SN 314 (e.g., reporting failure of the first RACH procedure between UE 310 and target MN 312) via a Msg3 (and the allocated or activated SRB) of the second RACH procedure, or via granted UL resources (and via SRB) after UE sends a buffer status report to the target SN 314 (e.g., where the SRB may not be generally activated for transmission of other type of messages or control information); and/or 2) only a SRB is activated to allow this reporting of a radio link failure report via RACH related message, and a data radio bearer for the target SN 314 is not activated yet (e.g., until a confirmation has been received by target SN 314 that a connection is established between UE 310 and a target MN 312).

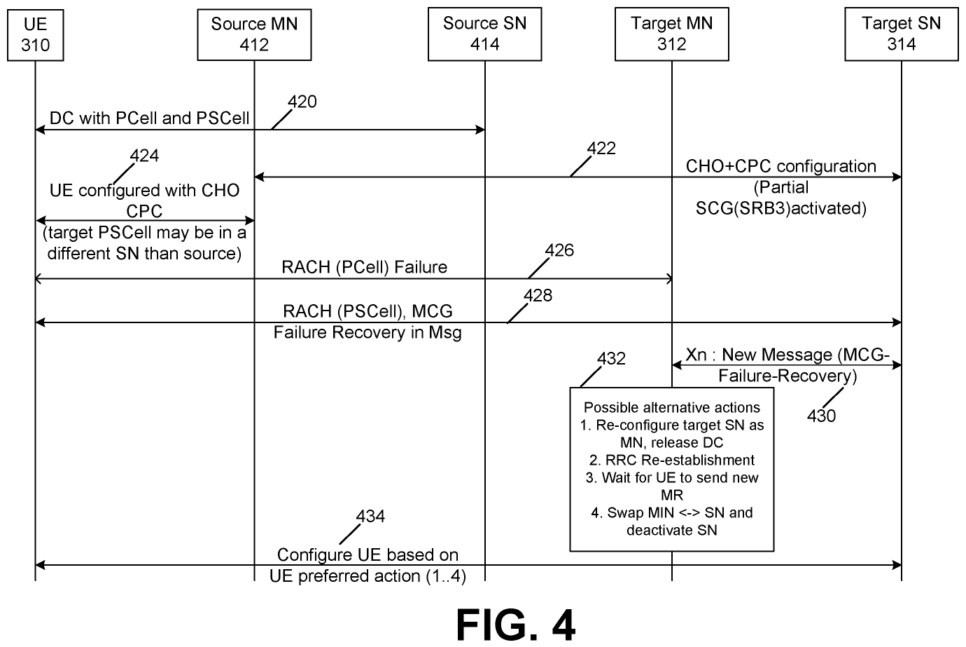

FIG. 4 is a diagram illustrating operation of a network according to an example embodiment. As shown in FIG. 4, a wireless network may include a UE, along with multiple network nodes, including a source MN 412, a source SN 414, a target MN 312 and a target SN 314. At 420, UE 310 is configured for dual connectivity (DC) with a PCell at source MN 412 and a PSCell at source SN 414.

At 422 and 424, UE 310 receives a conditional handover (CHO) configuration for a CHO to a target MN 312 and a CPC configuration for a conditional cell change or CHO to a target SN 314. Also, at 422, UE 310 may also receive preconfiguration information including information indicating a signaling radio bearer (SRB) for the target SN 314 to enable UE 310 to report failure of a first random access procedure between the UE and the target MN 312 via a second random access procedure with the target SN 314, regardless of whether a connection has been established between the UE 310 and target MN 312. For example, the preconfiguration information may include a SRB configuration for a partially activated SRB (e.g., for a SRB3 or split-SRB1) which has been activated for the target SN 314 to accept a random access (RACH) procedure Msg3 from the UE 310 that includes a radio link failure report, without activating a data radio bearer (DRB) for the target SN 314.

For example, the preconfiguration information may include one or more of: information indicating time-frequency resources to be used by the UE 310 for RACH procedure message transmission to the target SN 314; information indicating a RACH preamble to be used by the UE 310 for transmission of a Msg1 or random access preamble of a contention-free random access procedure to the target SN 314; and/or information indicating a partially activated SRB (e.g., a partially activated SRB3, or partially activated split-SRB1) that has been partially activated to enable the UE 310 to transmit, via the second random access procedure to the target SN 314, a radio link failure report indicating the failure of the first random access procedure with the target MN 312 (between the UE 310 and target MN 312), wherein the SRB may be used by the UE 310 to transmit the radio link failure report even though no connection has been established between the UE 310 and the target MN 312 (and a UE-target MN connection confirmation has not been communicated to the target SN 314).

The partially activated SRB may be considered partially activated (and not fully activated, or not part of a full SCG configuration) based on at least one of two conditions: 1) the SRB is only partially activated for the purpose of allowing the UE to send one or more RACH messages to target SN 314 (even though there is no connection between UE 310 and target MN 312), such as to allow UE 310 to send a radio link failure report to the target SN 314 (e.g., reporting failure of the first RACH procedure between UE 310 and target MN 312) via a RACH Msg3; and/or 2) a full SCG configuration for the target SN 314 is not provided or activated; and none of the data radio bearers (DRB) for the target SN 314 is activated (e.g., until a confirmation has been received by target SN 314 that a connection has been established between UE 310 and a target MN 312), and a SRB is activated by target SN 314, e.g., for the limited purpose of allowing the UE 310 to send a RACH message and/or to report (via a RACH message, such as Msg3, of the second RACH procedure with the target SN 314) to the target SN 314 of a detected radio link failure of the first RACH procedure (or failure of the UE 310-target MN radio link) between the UE 310 and target MN 312.

Referring to FIG. 4, at 426, the UE 310 may attempt a first RACH procedure with the target MN 312 (with PCell of target MN 312). UE 310 detects a failure of this first RACH procedure with the target MN 312, e.g., based on UE's failure to receive a RACH Msg2 from the target MN 312, for example.

At 428 of FIG. 4, the UE 310 may initiate a second RACH procedure with target SN 314. A RACH preamble may be sent (Msg1). Also, as part of the second RACH procedure, UE 310 may transmit (at 428) a radio link failure report (e.g., which may be provided as or within a MSG failure recovery message) to the target SN 314, via the activated (e.g., partially activated) SRB, to the target SN 314, reporting or indicating the failure of the first RACH procedure between UE 310 and target MN 312. For example, the failure of the first random access procedure with the target MN 312 may be detected by the UE during a handover of the UE from a source master cell group (MCG) primary cell (PCell) (source MN 412) to a target MCG PCell (target MN 312). Also, according to an example embodiment, the radio link failure report may include at least one of: a flag (or information) indicating the failure of the first RACH procedure with the target MN 312; a measurement report including latest or recent signal measurements performed by the UE with respect to one or more neighbor cells or neighbor network nodes; and/or a suggested or preferred action(s) to be performed (by the UE or a network node) in response to the failure of the first RACH procedure with the target MN 312.

Also, the transmitting a radio link failure report via the second RACH procedure may be performed in different ways. For example, the radio link failure report may be transmitted via at least one of the following ways: 1) transmitting, by the UE to the target SN 314 via Msg3 of the second RACH procedure and the (indicated or partially activated) SRB, including in the Msg3 (when UE has UL grant), the radio link failure report indicating that the first RACH procedure with the target MN 312 has failed; or 2) transmitting, by the UE 310 to the target SN 314 via Msg3 of the second RACH procedure and the SRB, a buffer status report requesting UL grant to transmit the RLF report; receiving, by the UE 310 from the target SN 314 based on the buffer status report, an uplink grant indicating granted resources; and transmitting, by the UE 310 to the target SN 314 via the granted resources and the SRB, the radio link failure report indicating the failure of the first RACH procedure with the target MN 312.

At 430, the target SN 314 forwards to the target MN 312, the radio link failure report, or information that reports a failure of the first RACH procedure between the UE 310 and the target MN 312. Also, at 430, the target MN 312 sends to target SN 314, information indicating an action to be performed (e.g., by the user device and/or a network node) in response to the failure of the first RACH procedure. At 434, target SN 314 forwards the MN selected action to be performed by UE, based on suggested action by UE and the reported failure of the first RACH procedure. At 434, target SN 314 sends a message to the UE 310 indicating the action to be performed by the UE 310 (or configuring UE 310 to perform an action) in response to the failure of the first random access procedure with the first network node.

At 432, the UE may be configured (e.g., by target MN 312 via target SN 314) to perform one or more actions, such as one or more of: requesting, by a network node, a measurement report from the user device; reconfiguring the target secondary node as the master node for the user device, and releasing dual connectivity for the user device; swapping the target secondary node with the target master node so as to promote the target secondary node to be a new master node for the user device and retaining the target master node as a suspended new secondary node for the user device; retain the target master node as suspended, and reconfigure radio bearers of target master node to be radio bearers of target secondary node; and activating radio resource control (RRC) re-establishment to cause the user device to establish a new connection with a master network node.

Various example embodiments may enable the UE to perform PSCell access on a CPC (conditional PSCell change prepared for one or more target SCG cell) prepared PSCell (target SN) despite PCell (target MN) RACH failure. This may be accomplished by pre-configuring the target SCG to respond to PSCell RACH-Access to enable reception of the radio link failure report (e.g., the MCG-Failure-Indication) over Msg3 (on SRB3, sent by UE).

Therefore, various example embodiments may include one or more of the following:

A UE may perform PSCell RACH (of SCG) access even when PCell (UE-target MN) RACH is unsuccessful. In one embodiment, if the UE is capable (which normally is the case as a DC UE has several receiver/transmitter chains as well as protocol stacks), the UE may attempt to perform parallel RACH access to both target MCG (target MN 312) and target SCG (target SN 314) to reduce delay in reporting failure. Or, the RACH procedures may be performed serially, or may overlap at least in part, as examples. However, the UE may typically send the Msg3 (with possibly the radio link failure report, in the event that the first RACH procedure with target MN 312 failed) to target SN 314 only after the UE has determined whether the first RACH procedure (target PCell access) with the target MN 312 was successful or has failed. Thus, the UE can then determine whether or not to include the radio link failure report within the Msg3 of the second RACH procedure with the target SN 314.

In case of independent CHO and CPC, same parallel access can be used for fast SCG failure report in case CPC fails. If PCell RACH fails and PSCell RACH succeeds, UE sends MCG-Failure-Recovery via. target SCG (via SRB3 or split-SRB1).

UE may also indicate its preferred way-forward action to the network in Msg3 of PSCell RACH with SCG.

This radio link failure report can be forwarded to target MN from target SN over Xn interface (network node to network node interface).

By way of examples, the target MN may perform one or more of the following actions based on the radio link failure report: Re-configure the UE with single connectivity with current PSCell as PCell; Continue in DC mode for a predefined time period and wait for UE to send measurements for a better PCell; UE is requested to perform RRC Re-establishment at the PCell (target MN); Re-configure the UE for dual connectivity with target SCG as PCell while the UE's MCG is reconfigured to a suspended SCG; Anchor the MCG bearers as SCG bearers; and/or, Target MN may also use it for AI-ML or SON related purposes. In case there is a requirement for the source MN to take the necessary actions after M-RLF, the failure report may typically be forwarded from target MN to source MN over the Xn interface.

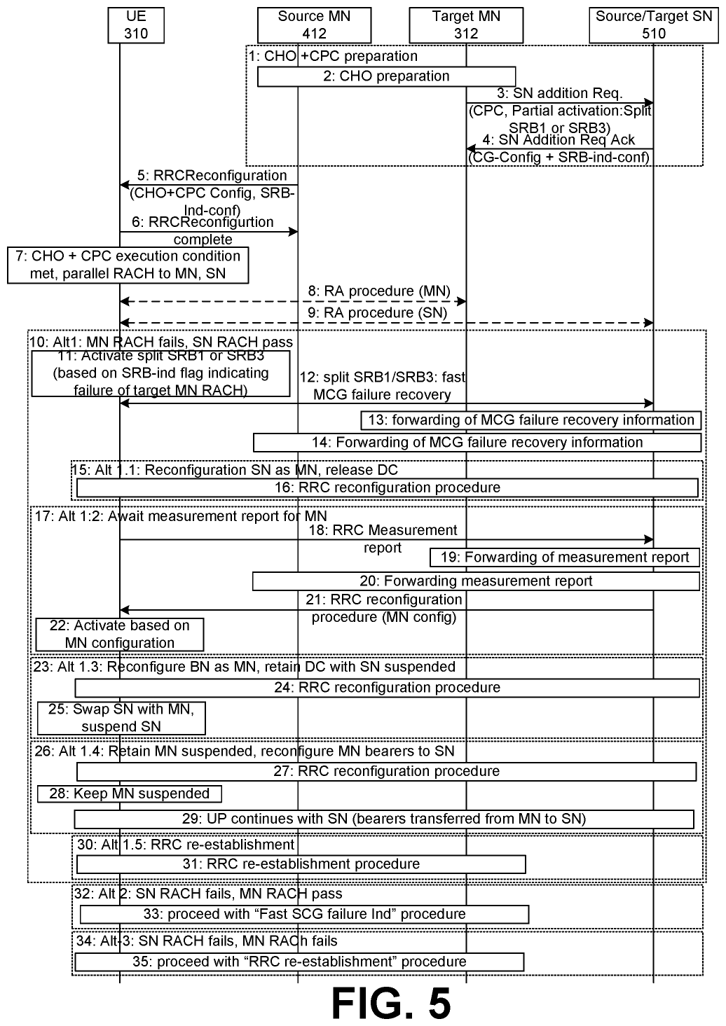

FIG. 5 is a diagram illustrating operation of a network according to another example embodiment. A UE 310, a source MN 412, a target MN 312, and a source and/or target SN 510 are shown in FIG. 5. Operations 1-34 (performed by the UE and/or various network nodes as shown) are briefly described. Operations 1-7 may involve preconfiguring resources, including a partially activated SRB, to allow the UE to send a radio link failure report to target SN to report failure of a first RACH procedure with target MN 312. Operations 8-9 illustrate the attempt by the UE 310 to perform a first RACH procedure (operation 8) with target MN 312 (which fails), and the use of a message(s) (e.g., Msg3) associated with a second RACH procedure (operation 9) with target SN 314 to report the failure of the first RACH procedure, and/or provide a suggested or proposed (by the UE) action to be performed in response to such failure. Operation 10 shows that the UE 310 detects the failure of the first RACH procedure with target MN 312. Operations 11-14 show the radio link failure report (MCG failure recovery information) reported by the UE 310 to the target SN, which is then forwarded to target MN, and target MN may determine an action to be performed based on reported radio link failure and proposed action by UE. At operations 15-34, a message is sent to the UE 310 indicating the action to be performed (by UE and/or network node(s)) (or UE 310 is configured to perform an action) in response to the radio link failure report. Various alternative actions are possible, and some are shown in operations 15-34 of FIG. 5. Further examples and details will now be described with reference to FIG. 5.

Steps 1-4 (of FIG. 5): In the CHO+CPC preparation procedure, target SN should be informed during CPC preparation to partially activate only SBR3/split SRB1 path configuration (out of the full SCG configuration) on reception of pre-assigned RACH preamble from UE on the PSCell. (Assuming CFRA resource are allocated). This can be accomplished by introducing an “SRB-ind” flag which tells the SN to make such a resource preparation to allow reporting of UE-target MN RACH failure via a second RACH procedure with target SN. The target SN may confirm the configuration using a “SRB-ind-Conf” flag. The same flag received from target SN can be indicated to the UE in Step 5.

Partially (such as partially activating a SRB) may mean, or may include, for example, activating only the SRB3 or SRB1 bearer configuration for receiving Msg3 and decoding it, at target SN. Actual activation of the full configuration and other bearers (e.g., including DRB) requires final confirmation from target MN that a connection has been established between UE and target MN. SRB3 or split-SRB1 configuration may be used for this fallback message reception (reception of the radio link failure report via Msg3 of second RACH procedure, indicating failure of first RACH procedure with target MN). In both cases, resources are activated at SCG to process the Msg3 (to allow target SN to receive or accept Msg 3, to receive radio link failure report), but other resources are not typically activated (since this is a limited activation of resources or SRB, to enable UE to report a detected radio link failure with first RACH procedure with target MN, via Msg3 of a second RACH procedure with target SN).

Steps 8,9: UE attempts sequential or parallel RACH access at both the target MN and target SN. Parallel RACH means, or may include that the UE initiates RACH access to both target PCell and PSCell simultaneously (or at least partially overlapping transmission of one or more RACH message(s)), but UE awaits completion (or failure) of first RACH procedure to PCell (target MN) before it transmits Msg3 to target PSCell (since UE will need to determine whether or not to include a radio link failure report, or not, within the Msg3 transmitted to target SN, depending on the failure or success of the first RACH procedure).

Step 10-14: Alt-1: If there is an unsuccessful RACH at PCell (target MN), UE sends fast MCG-Failure-Recovery via Target SCG (SRB3 or split-SRB1). The Steps 13 and 14 ensure the target SN forwards the information to the target MN to enable recovery procedure negotiation. Finally, the recovery message and decision is conveyed through the target SN to the UE.

Step 15-16: Alt 1-1 allows the target SN to be reconfigured as MN and release of DC. Target SN activates only the SRB3 bearer for reception of msg3 on detecting the UE's preamble. Alternatively, if split-SRB is configured, UE can send handover-complete via split-SRB. In this case SN needs to activate split part of SRB only. NOTE: Here, the assumption is that the split SRB-1 at SN is configured by the source MN.

Step 17-22: Alt 1-2 If network decides to wait for further measurement reporting, the UE continues the measurements and indicates when a suitable MN target cell is available via the SN. Finally at Step 22 the UE is able to make the access to the MN with the configuration provided by the network.

Step 23-25: Alt 1-3 if network wants to reconfigure or swap SN with MN and continue with the new SN in suspended for later reactivation.

Step 26-29: Alt 1-4 if network wants to retain MN in suspended form and continue data transfer via SN with bearers mapped to SCG (bearer type change from MN to SN or just use the split leg of SCG for bearers mapped to MN).

Step 30-31: Alt 1-5 if network wants to force RRC re-establishment.

Step 32-33: Alt 2 if SN RACH fails but MN RACH procedure succeeds, fast recovery of SCG is possible by early indication using Step 33.

Step 34-35: Alt 3 If both RACH fails this defaults to normal re-establishment procedure in Step 35.

Example Embodiment for non-contention free random access (non-CFRA case, which is a contention based random access):

In case CFRA (contention free random access) allocation is not possible at the target SN, a new temporary identity could be introduced to allow SN to activate the SRB3/split SRB1 during RACH (for a UE reporting M-RLF via SRB3). The new temporary identity is provided by the target SN and signaled to the UE via the RRC Reconfiguration (step 5) provided by source MN.

The UE includes this temporary identity during the PSCell RACH access and the network identifies that the “partial” SCG configuration needs to be activated for the UE. This would happen at Step 12 in the above figure.

Enabling target SCG to respond to UE RACH-Access and reception of MCG-Failure-Indication over Msg3.

This requires the Target MN to indicate Target SN to prepare ‘light or partial configuration’ for possible reception of Msg3 containing MCG-failure recovery indication before SGNB-Reconfig-Complete.

Once target SCG is configured for such Msg3 reception, It can receive MCG-Failure-recovery-Indication via Msg3 even before SGNB-Reconfiguration-complete from the MN. UE includes the measurement result at the time HO-execution in this Msg3. May include only few best-cells to fit into Msg3 size.

Source MN configures the UE to start the SCG access for failure reporting as part of Handover or CHO configuration.

Also, for example, upon timer T304 expiry (or other detection of radio link failure of UE-target MN link, or detected failure of first RACH procedure with target MN), UE completes PSCell (target SN) RACH access and sends Msg3 (to target SN) containing radio link failure report, which may be implemented as a MCG-Failure-recovery-indication (It may not be a fast recovery here). Here it can be SRB3 bearer config or split-SRB config.

SCG receives this radio link failure report, as it has already activated the partial configuration and forwards this radio link failure report to Source/Target MN. Network prepares a new PCell-configuration (for a MN for the UE) based on measurement results (based on UE indicated preference).

5. Anchoring the MCG bearers as SCG bearers. Anchoring here means routing the MCG bearer data via target SN, until a better PCell is found and UE reconfigured. This may be performed to avoid manipulating CHO configuration and execution.

Full fallback configuration (option 1, step 15 in FIG. 2) may be used in case of delayed CHO execution. T314 timer will be stopped, and may be reset.

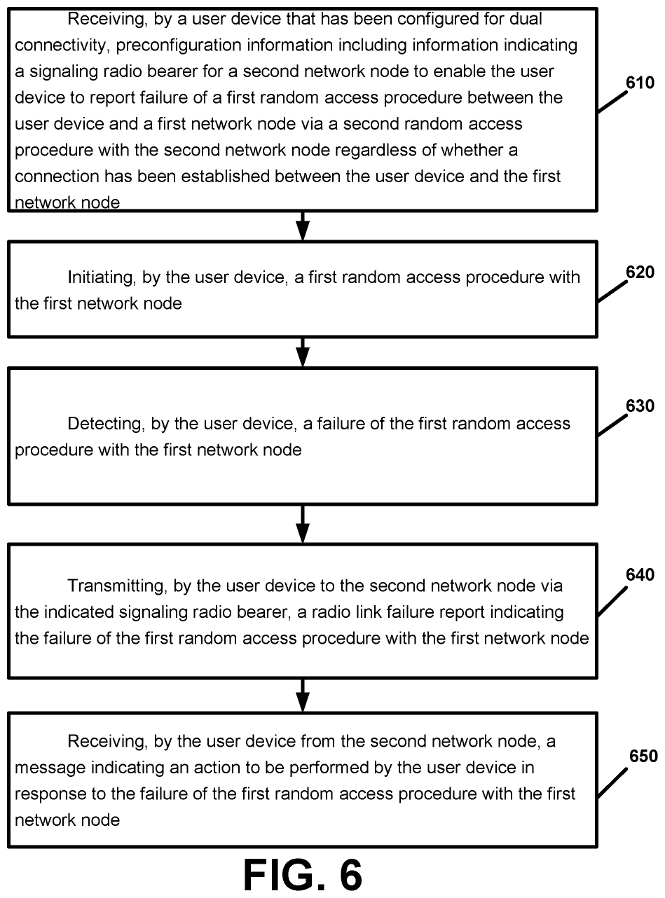

Example 1. FIG. 6 is flow chart illustrating operation of a user device (or UE) according to an example embodiment. Operation 610 includes receiving, by a user device that has been configured for dual connectivity, preconfiguration information including information indicating a signaling radio bearer for a second network node to enable the user device to report failure of a first random access procedure between the user device and a first network node via a second random access procedure with the second network node regardless of whether a connection has been established between the user device and the first network node. Operation 620 includes initiating, by the user device, a first random access procedure with the first network node. Operation 630 includes detecting, by the user device, a failure of the first random access procedure with the first network node. Operation 640 includes transmitting, by the user device to the second network node via the indicated signaling radio bearer, a radio link failure report indicating the failure of the first random access procedure with the first network node. And, operation 650 includes receiving, by the user device from the second network node, a message indicating an action to be performed by the user device in response to the failure of the first random access procedure with the first network node.

Example 2. The method of example 1, wherein the first network node is configured as a master node, and the second network node is configured as a secondary node as part of dual connectivity for the user device.

Example 3. The method of example 1, wherein: the second random access procedure comprises the user device transmitting a first Msg1 to the second network node as part of the second random access procedure with the second network node, at least partially in parallel with the user device transmitting a second Msg1 to the first network node as part of the first random access procedure with the first network node; and the transmitting the radio link failure report comprises transmitting, by the user device, the radio link failure report to the second network node via the indicated signaling radio bearer and via a Msg3 of the second random access procedure after a failure of the first random access procedure has been detected by the user device.

Example 4. The method of any of examples 1-3, wherein the signaling radio bearer comprises a partially activated signaling radio bearer for the second network node that is activated only for the purpose of enabling the user device to report, to the second network node via the partially activated signaling radio bearer and a message of the second random access procedure, a failure of the first random access procedure between the user device and the first network node, regardless of whether the second network node has received a confirmation from the first network node that a connection has been established between the user device and the first network node, without requiring activation of a data radio bearer for the second network node for the user device.

Example 5. The method of any of examples 1-4, wherein the first network node comprises a target master node, and the second network node comprises a target secondary node, wherein a handover of the user device to the target master node has failed or a connection establishment or a random access procedure of the user device to the target master node has failed.

Example 6. The method of any of examples 1-5, wherein the preconfiguration information comprises a signaling radio bearer configuration for a partially activated signaling radio bearer 3 (SRB3) which has been activated for the second network node to accept a random access procedure Msg3 from the user device that includes the radio link failure report, without activating a data radio bearer (DRB) for the second network node.

Example 7. The method of any of examples 1-6, wherein the failure of the first random access procedure with the first network node is detected by the user device during a handover of the user device from a source master cell group (MCG) primary cell (PCell) to a target MCG PCell.

Example 8. The method of any of examples 1-7, wherein the radio link failure report comprises at least one of: a flag indicating the failure of the first random access procedure with the first network node; a measurement report including latest measurements performed by the user device with respect to one or more neighbor cells or network nodes; a suggested or preferred action to be performed in response to the failure of the first random access procedure with the first network node.

Example 9. The method of any of examples 1-8, wherein the receiving preconfiguration information comprises receiving, by the user device, one or more of: information indicating time-frequency resources to be used by the user device for random access procedure message transmission to the second network node; information indicating a random access preamble to be used by the user device for transmission of a Msg1 or random access preamble of a contention-free random access procedure with the second network node; or information indicating a partially activated signaling radio bearer that has been partially activated to enable the user device to transmit, via the second random access procedure to the second network node, a radio link failure report indicating the failure of the first random access procedure with the first network node, wherein the signaling radio bearer may be used to transmit the radio link failure report even though no connection has been established between the user device and the first network node.

Example 10. The method of example 1, wherein the transmitting comprises: transmitting, by the user device to the second network node via Msg3 of the second random access procedure and the signaling radio bearer, the radio link failure report indicating that the first random access procedure with the first network node has failed.

Example 11. The method of example 1, wherein the transmitting comprises: transmitting, by the user device to the second network node via Msg3 of the second random access procedure and the signaling radio bearer, a buffer status report; receiving, by the user device from the second network node based on the buffer status report, an uplink grant indicating granted resources; and, transmitting, by the user device to the second network node via the granted resources and the signaling radio bearer, the radio link failure report indicating the failure of the first random access procedure with the first network node.

Example 12. The method of any of examples 1-11, wherein the first network node comprises a target master node, and the second network node comprises a target secondary node, and wherein the action to be performed by the user device in response to the failure of the first random access procedure comprises at least one of the following: requesting, by a network node, a measurement report from the user device; reconfiguring the target secondary node as the master node for the user device, and releasing dual connectivity for the user device; swapping the target secondary node with the target master node so as to promote the target secondary node to be a new master node for the user device and making the target master node to be a new secondary node for the user device, and suspending the new secondary node; retain the target master node as suspended, and reconfigure radio bearers of target master node to be radio bearers of target secondary node; and activating radio resource control (RRC) re-establishment to cause the user device to establish a new connection with a master network node.

Example 13. An apparatus comprising: at least one processor; and at least one memory including computer program code; the at least one memory and the computer program code configured to, with the at least one processor, cause the apparatus at least to: receive, by a user device that has been configured for dual connectivity, preconfiguration information including information indicating a signaling radio bearer for a second network node to enable the user device to report failure of a first random access procedure between the user device and a first network node, via a second random access procedure with the second network node regardless of whether a connection has been established between the user device and the first network node; initiate, by the user device, a first random access procedure with the first network node; detect, by the user device, a failure of the first random access procedure with the first network node; transmit, by the user device to the second network node via the indicated signaling radio bearer, a radio link failure report indicating the failure of the first random access procedure with the first network node; and receive, by the user device from the second network node, a message indicating an action to be performed by the user device in response to the failure of the first random access procedure with the first network node.

Example 14. The apparatus of example 13, wherein the first network node is configured as a master node, and the second network node is configured as a secondary node as part of dual connectivity for the user device.

Example 15. The apparatus of example 13, wherein the at least one processor and the computer program code are configured to: the second random access procedure comprises the user device transmitting a first Msg1 to the second network node as part of the second random access procedure with the second network node, at least partially in parallel with the user device transmitting a second Msg1 to the first network node as part of the first random access procedure with the first network node; and the transmitting the radio link failure report comprises transmitting, by the user device, the radio link failure report to the second network node via the indicated signaling radio bearer and via a Msg3 of the second random access procedure after a failure of the first random access procedure has been detected by the user device.

Example 16. The apparatus of any of examples 13-15, wherein the signaling radio bearer comprises a partially activated signaling radio bearer for the second network node that is activated only for the purpose of enabling the user device to report, to the second network node via the partially activated signaling radio bearer and a message of the second random access procedure, a failure of the first random access procedure between the user device and the first network node, regardless of whether the second network node has received a confirmation from the first network node that a connection has been established between the user device and the first network node, without requiring activation of a data radio bearer for the second network node for the user device.

Example 17. The apparatus of any of examples 13-16, wherein the first network node comprises a target master node, and the second network node comprises a target secondary node, wherein a handover of the user device to the target master node has failed or a connection establishment or a random access procedure of the user device to the target master node has failed.

Example 18. The apparatus of any of examples 13-17, wherein the preconfiguration information comprises a signaling radio bearer configuration for a partially activated signaling radio bearer 3 (SRB3) which has been activated for the second network node to accept a random access procedure Msg3 from the user device that includes the radio link failure report, without activating a data radio bearer (DRB) for the second network node.

Example 19. The apparatus of any of examples 13-18, wherein the failure of the first random access procedure with the first network node is detected by the user device during a handover of the user device from a source master cell group (MCG) primary cell (PCell) to a target MCG PCell.

Example 20. The apparatus of any of examples 13-19, wherein the radio link failure report comprises at least one of: a flag indicating the failure of the first random access procedure with the first network node; a measurement report including latest measurements performed by the user device with respect to one or more neighbor cells or network nodes; or a suggested or preferred action to be performed in response to the failure of the first random access procedure with the first network node.

Example 21. The apparatus of any of examples 13-20, wherein the at least one processor and the computer program code configured to cause the apparatus to receive preconfiguration information comprises the at least one processor and the computer program code configured to cause the apparatus to receive, by the user device, one or more of: information indicating time-frequency resources to be used by the user device for random access procedure message transmission to the second network node; information indicating a random access preamble to be used by the user device for transmission of a Msg1 or random access preamble of a contention-free random access procedure with the second network node; or information indicating a partially activated signaling radio bearer that has been partially activated to enable the user device to transmit, via the second random access procedure to the second network node, a radio link failure report indicating the failure of the first random access procedure with the first network node, wherein the signaling radio bearer may be used to transmit the radio link failure report even though no connection has been established between the user device and the first network node.

Example 22. The apparatus of example 13, wherein the at least one processor and the computer program code configured to cause the apparatus to transmit comprises the at least one processor and the computer program code configured to cause the apparatus to: transmit, by the user device to the second network node via Msg3 of the second random access procedure and the signaling radio bearer, the radio link failure report indicating that the first random access procedure with the first network node has failed.

Example 23. The apparatus of example 13, wherein the at least one processor and the computer program code configured to cause the apparatus to transmit comprises the at least one processor and the computer program code configured to cause the apparatus to: transmit, by the user device to the second network node via Msg3 of the second random access procedure and the signaling radio bearer, a buffer status report; receive, by the user device from the second network node based on the buffer status report, an uplink grant indicating granted resources; and transmit, by the user device to the second network node via the granted resources and the signaling radio bearer, the radio link failure report indicating the failure of the first random access procedure with the first network node.

Example 24. The apparatus of any of examples 13-23, wherein the first network node comprises a target master node, and the second network node comprises a target secondary node, and wherein the action to be performed by the user device in response to the failure of the first random access procedure comprises at least one of the following: requesting, by a network node, a measurement report from the user device; reconfiguring the target secondary node as the master node for the user device, and releasing dual connectivity for the user device; swapping the target secondary node with the target master node so as to promote the target secondary node to be a new master node for the user device and making the target master node to be a new secondary node for the user device, and suspending the new secondary node; retain the target master node as suspended, and reconfigure radio bearers of target master node to be radio bearers of target secondary node; or activating radio resource control (RRC) re-establishment to cause the user device to establish a new connection with a master network node.

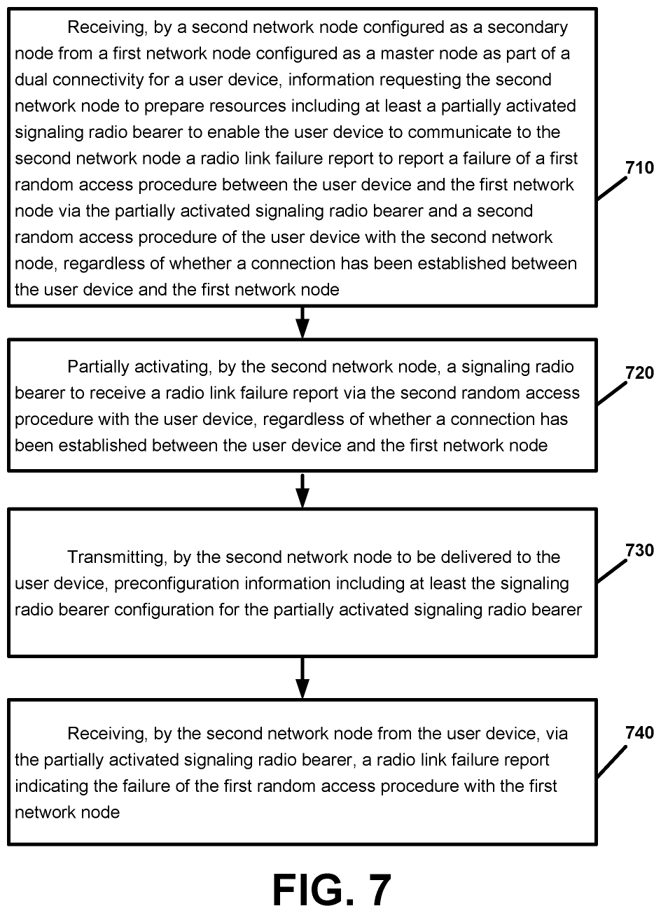

Example 25. FIG. 7 is a flow chart illustrating operation of a network node (such as a target secondary node) according to an example embodiment. Operation 710 includes receiving, by a second network node configured as a secondary node from a first network node configured as a master node as part of a dual connectivity for a user device, information requesting the second network node to prepare resources including at least a partially activated signaling radio bearer to enable the user device to communicate to the second network node a radio link failure report to report a failure of a first random access procedure between the user device and the first network node via the partially activated signaling radio bearer and a second random access procedure of the user device with the second network node, regardless of whether a connection has been established between the user device and the first network node. Operation 720 includes partially activating, by the second network node, a signaling radio bearer to receive a radio link failure report via the second random access procedure with the user device, regardless of whether a connection has been established between the user device and the first network node. Operation 730 includes transmitting, by the second network node to be delivered to the user device, preconfiguration information including at least the signaling radio bearer configuration for the partially activated signaling radio bearer. Operation 740 includes receiving, by the second network node from the user device, via the partially activated signaling radio bearer, a radio link failure report indicating the failure of the first random access procedure with the first network node.

Example 26. The method of example 25, wherein the transmitting preconfiguration information comprises: transmitting, by the second network node to be delivered to the user device, preconfiguration information including at least the signaling radio bearer configuration for the partially activated signaling radio bearer, and information identifying a random access preamble to be used by the user device as part of the second random access procedure between the user device and the second network node.

Example 27. The method of example 25, further comprising: transmitting, by the second network node to the first network node, the radio link failure report received from the user device; receiving, by the second network node from the first network node a message indicating the action to be performed by the user equipment after the failure of the first random access procedure for the user device with the first network node; transmitting, by the second network node to the user device, a message indicating an action to be performed by the user device in response to the failure of the first random access procedure with the first network node.

Example 28. The method of any of examples 25-27, wherein the first network node comprises a target master node, and the second network node comprises a target secondary node, wherein a handover of the user device to the target master node has failed or a connection establishment or a random access procedure of the user device to the target master node has failed.

Example 29. The method of any of examples 25-28, wherein the preconfiguration information comprises a signaling radio bearer configuration for a partially activated signaling radio bearer 3 (SRB3) which has been activated for the second network node to accept a random access procedure Msg3 from the user device that includes the radio link failure report, without activating a data radio bearer (DRB) for the second network node.

Example 30. The method of any of examples 25-29, wherein the radio link failure report comprises: a flag indicating the failure of the first random access procedure with the first network node; a measurement report including latest measurements performed by the user device with respect to one or more neighbor cells or network nodes; a suggested or preferred action to be performed in response to the failure of the first random access procedure with the first network node.

Example 31. The method of any of examples 25-30, wherein the preconfiguration information comprises one or more of: information indicating time-frequency resources to be used by the user device for random access procedure message transmission to the second network node; information indicating a random access preamble to be used by the user device for transmission of a Msg1 or random access preamble of a contention-free random access procedure with the second network node; or information indicating a partially activated signaling radio bearer that has been partially activated to enable the user device to transmit, via the second random access procedure to the second network node, a radio link failure report indicating the failure of the first random access procedure with the first network node, wherein the signaling radio bearer may be used to transmit the radio link failure report even though no connection has been established between the user device and the first network node.

Example 32. The method of any of examples 25-31, wherein the receiving, by the second network node from the user device, via the partially activated signaling radio bearer, a radio link failure report comprises: receiving, by the second network node from the user device, via a random access procedure Msg3 of the second random access procedure and via the partially activated signaling radio bearer, a radio link failure report.

Example 33. The method of any of examples 25-32, wherein the receiving, by the second network node from the user device, via the partially activated signaling radio bearer, a radio link failure report comprises: receiving, by the second network node from the user device via Msg3 of the second random access procedure and the signaling radio bearer, a buffer status report; transmitting, by the second network node to the user device from based on the buffer status report, an uplink grant indicating granted resources; receiving, the second network node from the user device via the granted resources and the signaling radio bearer, the radio link failure report indicating the failure of the first random access procedure with the first network node.

Example 34. The method of any of examples 25-33, wherein the first network node comprises a target master node, and the second network node comprises a target secondary node, and wherein the action to be performed by the user device in response to the failure of the first random access procedure comprises at least one of the following: requesting, by a network node, a measurement report from the user device; reconfiguring the target secondary node as the master node for the user device, and releasing dual connectivity for the user device; swapping the target secondary node with the target master node so as to promote the target secondary node to be a new master node for the user device and making the target master node to be a new secondary node for the user device, and suspending the new secondary node; retain the target master node as suspended, and reconfigure radio bearers of target master node to be radio bearers of target secondary node; and activating radio resource control (RRC) re-establishment to cause the user device to establish a new connection with a master network node.

Example 35. An apparatus comprising: at least one processor; and at least one memory including computer program code; the at least one memory and the computer program code configured to, with the at least one processor, cause the apparatus at least to: receive, by a second network node configured as a secondary node from a first network node configured as a master node as part of a dual connectivity for a user device, information requesting the second network node to prepare resources including at least a partially activated signaling radio bearer to enable the user device to communicate a radio link failure report to report a failure of a first random access procedure between the user device and the first network node via the partially activated signaling radio bearer and a second random access procedure of the user device with the second network node, regardless of whether a connection has been established between the user device and the first network node; partially activate, by the second network node, a signaling radio bearer to receive a radio link failure report via the second random access procedure with the user device, regardless of whether a connection has been established between the user device and the first network node; transmit, by the second network node to be delivered to the user device, preconfiguration information including at least the signaling radio bearer configuration for the partially activated signaling radio bearer; and receive, by the second network node from the user device, via the partially activated signaling radio bearer, a radio link failure report indicating the failure of the first random access procedure with the first network node.

Example 36. The apparatus of example 35, wherein the at least one processor and the computer program code configured to transmit preconfiguration information comprises the at least one processor and the computer program code configured to cause the apparatus to: transmit, by the second network node to be delivered to the user device, preconfiguration information including at least the signaling radio bearer configuration for the partially activated signaling radio bearer, and information identifying a random access preamble to be used by the user device as part of the second random access procedure between the user device and the second network node.

Example 37. The apparatus of example 35, wherein the at least one processor and the computer program code are configured to further cause the apparatus to: transmit, by the second network node to the first network node, the radio link failure report received from the user device; receive, by the second network node from the first network node a message indicating the action to be performed by the user equipment after the failure of the first random access procedure for the user device with the first network node; and transmit, by the second network node to the user device, a message indicating an action to be performed by the user device in response to the failure of the first random access procedure with the first network node.

Example 38. The apparatus of any of examples 35-37, wherein the first network node comprises a target master node, and the second network node comprises a target secondary node, wherein a handover of the user device to the target master node has failed or a connection establishment or a random access procedure of the user device to the target master node has failed.

Example 39. The apparatus of any of examples 35-38, wherein the preconfiguration information comprises a signaling radio bearer configuration for a partially activated signaling radio bearer 3 (SRB3) which has been activated for the second network node to accept a random access procedure Msg3 from the user device that includes the radio link failure report, without activating a data radio bearer (DRB) for the second network node.

Example 40. The apparatus of any of examples 35-39, wherein the radio link failure report comprises at least one of: a flag indicating the failure of the first random access procedure with the first network node; a measurement report including latest measurements performed by the user device with respect to one or more neighbor cells or network nodes; a suggested or preferred action to be performed in response to the failure of the first random access procedure with the first network node.

Example 41. The apparatus of any of examples 35-40, wherein the preconfiguration information comprises one or more of: information indicating time-frequency resources to be used by the user device for random access procedure message transmission to the second network node; information indicating a random access preamble to be used by the user device for transmission of a Msg1 or random access preamble of a contention-free random access procedure with the second network node; or information indicating a partially activated signaling radio bearer that has been partially activated to enable the user device to transmit, via the second random access procedure to the second network node, a radio link failure report indicating the failure of the first random access procedure with the first network node, wherein the signaling radio bearer may be used to transmit the radio link failure report even though no connection has been established between the user device and the first network node.

Example 42. The apparatus of any of examples 35-41, wherein the at least one processor and the computer program code configured to receive, by the second network node from the user device, via the partially activated signaling radio bearer, a radio link failure report comprises the at least one processor and the computer program code configured to: receive, by the second network node from the user device, via a random access procedure Msg3 of the second random access procedure and via the partially activated signaling radio bearer, a radio link failure report.

Example 43. The apparatus of any of examples 35-41, wherein the at least one processor and the computer program code configured to receive, by the second network node from the user device, via the partially activated signaling radio bearer, a radio link failure report comprises the at least one processor and the computer program code configured to: receive, by the second network node from the user device via Msg3 of the second random access procedure and the signaling radio bearer, a buffer status report; transmit, by the second network node to the user device from based on the buffer status report, an uplink grant indicating granted resources; and receiving, the second network node from the user device via the granted resources and the signaling radio bearer, the radio link failure report indicating the failure of the first random access procedure with the first network node.

Example 44. The apparatus of any of examples 35-43, wherein the first network node comprises a target master node, and the second network node comprises a target secondary node, and wherein the action to be performed by the user device in response to the failure of the first random access procedure comprises at least one of the following: requesting, by a network node, a measurement report from the user device; reconfiguring the target secondary node as the master node for the user device, and releasing dual connectivity for the user device; swapping the target secondary node with the target master node so as to promote the target secondary node to be a new master node for the user device and making the target master node to be a new secondary node for the user device, and suspending the new secondary node; retain the target master node as suspended, and reconfigure radio bearers of target master node to be radio bearers of target secondary node; and activating radio resource control (RRC) re-establishment to cause the user device to establish a new connection with a master network node.

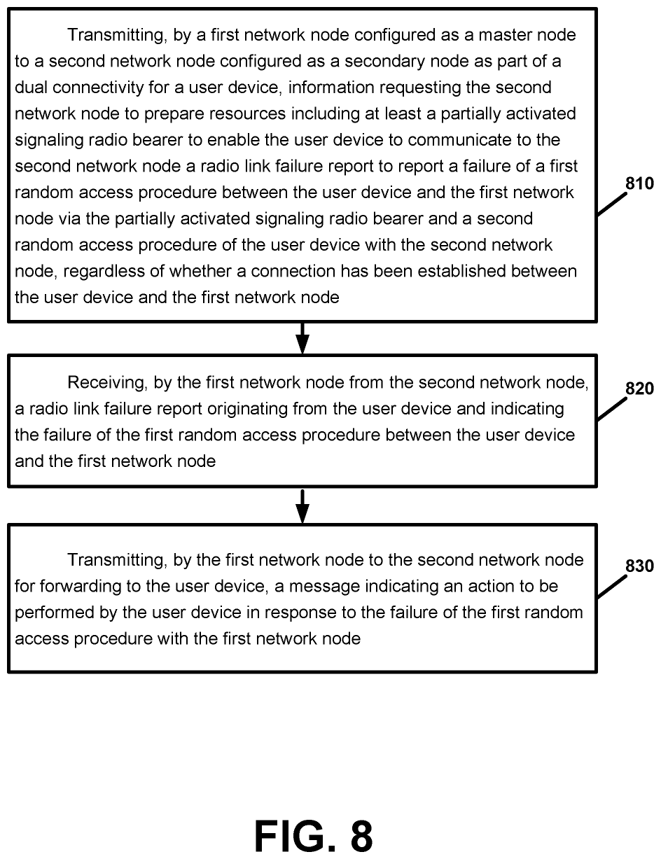

Example 45. FIG. 8 is a flow chart illustrating operation of a network node (e.g., such as a target master node) according to an example embodiment. Operation 810 includes transmitting, by a first network node configured as a master node to a second network node configured as a secondary node as part of a dual connectivity for a user device, information requesting the second network node to prepare resources including at least a partially activated signaling radio bearer to enable the user device to communicate to the second network node a radio link failure report to report a failure of a first random access procedure between the user device and the first network node via the partially activated signaling radio bearer and a second random access procedure of the user device with the second network node, regardless of whether a connection has been established between the user device and the first network node. Operation 820 includes receiving, by the first network node from the second network node, a radio link failure report originating from the user device and indicating the failure of the first random access procedure between the user device and the first network node. And, operation 830 includes transmitting, by the first network node to the second network node for forwarding to the user device, a message indicating an action to be performed by the user device in response to the failure of the first random access procedure with the first network node.

Example 46. The method of example 45, wherein the first network node comprises a target master node, and the second network node comprises a target secondary node, and wherein the action to be performed by the user device in response to the failure of the first random access procedure comprises at least one of the following: requesting, by a network node, a measurement report from the user device; reconfiguring the target secondary node as the master node for the user device, and releasing dual connectivity for the user device; swapping the target secondary node with the target master node so as to promote the target secondary node to be a new master node for the user device and making the target master node to be a new secondary node for the user device, and suspending the new secondary node; retain the target master node as suspended, and reconfigure radio bearers of target master node to be radio bearers of target secondary node; and activating radio resource control (RRC) re-establishment to cause the user device to establish a new connection with a master network node.

Example 47. An apparatus comprising: at least one processor; and at least one memory including computer program code; the at least one memory and the computer program code configured to, with the at least one processor, cause the apparatus at least to: transmit, by a first network node configured as a master node to a second network node configured as a secondary node as part of a dual connectivity for a user device, information requesting the second network node to prepare resources including at least a partially activated signaling radio bearer to enable the user device to communicate to the second network node a radio link failure report to report a failure of a first random access procedure between the user device and the first network node via the partially activated signaling radio bearer and a second random access procedure of the user device with the second network node, regardless of whether a connection has been established between the user device and the first network node; receive, by the first network node from the second network node, a radio link failure report originating from the user device and indicating the failure of the first random access procedure between the user device and the first network node; transmit, by the first network node to the second network node for forwarding to the user device, a message indicating an action to be performed by the user device in response to the failure of the first random access procedure with the first network node.

Example 48. The apparatus of example 47, wherein the first network node comprises a target master node, and the second network node comprises a target secondary node, and wherein the action to be performed by the user device in response to the failure of the first random access procedure comprises at least one of the following: requesting, by a network node, a measurement report from the user device; reconfiguring the target secondary node as the master node for the user device, and releasing dual connectivity for the user device; swapping the target secondary node with the target master node so as to promote the target secondary node to be a new master node for the user device and making the target master node to be a new secondary node for the user device, and suspending the new secondary node; retain the target master node as suspended, and reconfigure radio bearers of target master node to be radio bearers of target secondary node; and activating radio resource control (RRC) re-establishment to cause the user device to establish a new connection with a master network node.

Example 49. An apparatus comprising means for performing the method of any of examples 1-12, 25-34 and 45-46.

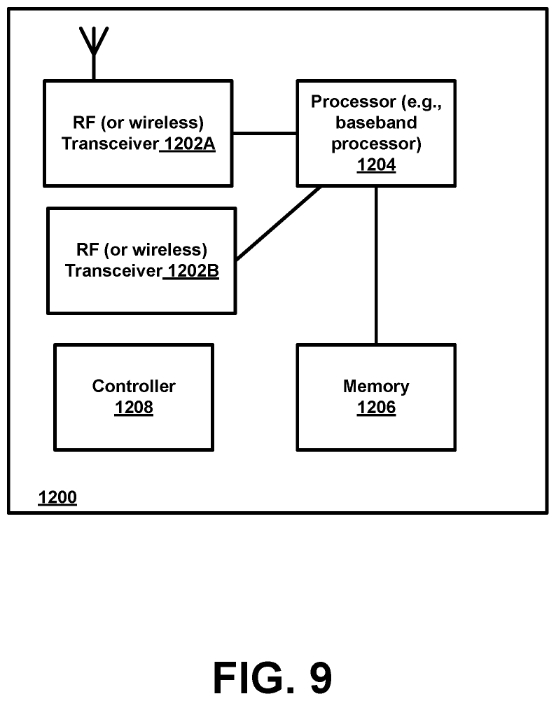

FIG. 9 is a block diagram of a wireless station (e.g., AP, BS or user device/UE, or other network node) 1200 according to an example embodiment. The wireless station 1200 may include, for example, one or more (e.g., two as shown in FIG. 9) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 9, a controller (or processor) 1208 may execute software and instructions, and may provide overall control for the station 1200, and may provide control for other systems not shown in FIG. 9, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G may be similar to that of LTE-advanced. 5G is likely to use multiple input-multiple output (MIMO) antennas, many more base stations or nodes than LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node may be operationally coupled to a remote radio head. It is also possible that node operations will be distributed among a plurality of servers, nodes or hosts. It should also be understood that the distribution of labour between core network operations and base station operations may differ from that of the LTE or even be non-existent.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a standalone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a backend component, e.g., as a data server, or that includes a middleware component, e.g., an application server, or that includes a frontend component, e.g., a client computer having a graphical user interface or a Web browser through which a user can interact with an embodiment, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-12. (canceled)

13. An apparatus comprising:
at least one processor; and
at least one memory including computer program code;
the at least one memory and the computer program code configured to, with the at least one processor, cause the apparatus at least to:
receive, by a user device that has been configured for dual connectivity, preconfiguration information including information indicating a signaling radio bearer for a second network node to enable the user device to report failure of a first random access procedure between the user device and a first network node, via a second random access procedure with the second network node regardless of whether a connection has been established between the user device and the first network node;
initiate, by the user device, a first random access procedure with the first network node;
detect, by the user device, a failure of the first random access procedure with the first network node;
transmit, by the user device to the second network node via the indicated signaling radio bearer, a radio link failure report indicating the failure of the first random access procedure with the first network node; and
receive, by the user device from the second network node, a message indicating an action to be performed by the user device in response to the failure of the first random access procedure with the first network node.

14. The apparatus of claim 13, wherein the first network node is configured as a master node, and the second network node is configured as a secondary node as part of dual connectivity for the user device.

15. The apparatus of claim 13, wherein the at least one processor and the computer program code are configured to:
the second random access procedure comprises the user device transmitting a first Msg1 to the second network node as part of the second random access procedure with the second network node, at least partially in parallel with the user device transmitting a second Msg1 to the first network node as part of the first random access procedure with the first network node; and
the transmitting the radio link failure report comprises transmitting, by the user device, the radio link failure report to the second network node via the indicated signaling radio bearer and via a Msg3 of the second random access procedure after a failure of the first random access procedure has been detected by the user device.

16. The apparatus of claim 13, wherein the signaling radio bearer comprises a partially activated signaling radio bearer for the second network node that is activated only for the purpose of enabling the user device to report, to the second network node via the partially activated signaling radio bearer and a message of the second random access procedure, a failure of the first random access procedure between the user device and the first network node, regardless of whether the second network node has received a confirmation from the first network node that a connection has been established between the user device and the first network node, without requiring activation of a data radio bearer for the second network node for the user device.

17. The apparatus of claim 13, wherein the first network node comprises a target master node, and the second network node comprises a target secondary node, wherein a handover of the user device to the target master node has failed or a connection establishment or a random access procedure of the user device to the target master node has failed.

18. The apparatus of claim 13, wherein the preconfiguration information comprises a signaling radio bearer configuration for a partially activated signaling radio bearer 3 (SRB3) or split-SRB1, which has been activated for the second network node to accept a random access procedure Msg3 from the user device that includes the radio link failure report, without activating a data radio bearer (DRB) for the second network node.

19. The apparatus of claim 13, wherein the failure of the first random access procedure with the first network node is detected by the user device during a handover of the user device from a source master cell group (MCG) primary cell (PCell) to a target MCG PCell.

20. The apparatus of claim 13, wherein the radio link failure report comprises at least one of:
a flag indicating the failure of the first random access procedure with the first network node;
a measurement report including latest measurements performed by the user device with respect to one or more neighbor cells or network nodes; or
a suggested or preferred action to be performed in response to the failure of the first random access procedure with the first network node.

21. The apparatus of claim 13, wherein the at least one processor and the computer program code configured to cause the apparatus to receive preconfiguration information comprises the at least one processor and the computer program code configured to cause the apparatus to receive, by the user device, one or more of:
information indicating time-frequency resources to be used by the user device for random access procedure message transmission to the second network node;
information indicating a random access preamble to be used by the user device for transmission of a Msg1 or random access preamble of a contention-free random access procedure with the second network node; or
information indicating a partially activated signaling radio bearer that has been partially activated to enable the user device to transmit, via the second random access procedure to the second network node, a radio link failure report indicating the failure of the first random access procedure with the first network node, wherein the signaling radio bearer may be used to transmit the radio link failure report even though no connection has been established between the user device and the first network node.

22. The apparatus of claim 13, wherein the at least one processor and the computer program code configured to cause the apparatus to transmit comprises the at least one processor and the computer program code configured to cause the apparatus to:
transmit, by the user device to the second network node via Msg3 of the second random access procedure and the signaling radio bearer, the radio link failure report indicating that the first random access procedure with the first network node has failed.

23. The apparatus of claim 13, wherein the at least one processor and the computer program code configured to cause the apparatus to transmit comprises the at least one processor and the computer program code configured to cause the apparatus to:
transmit, by the user device to the second network node via Msg3 of the second random access procedure and the signaling radio bearer, a buffer status report;
receive, by the user device from the second network node based on the buffer status report, an uplink grant indicating granted resources; and
transmit, by the user device to the second network node via the granted resources and the signaling radio bearer, the radio link failure report indicating the failure of the first random access procedure with the first network node.

24. The apparatus of claim 13, wherein the first network node comprises a target master node, and the second network node comprises a target secondary node, and wherein the action to be performed by the user device in response to the failure of the first random access procedure comprises at least one of the following:
requesting, by a network node, a measurement report from the user device;
reconfiguring the target secondary node as the master node for the user device, and releasing dual connectivity for the user device;
swapping the target secondary node with the target master node so as to promote the target secondary node to be a new master node for the user device and making the target master node to be a new secondary node for the user device, and suspending the new secondary node;
retain the target master node as suspended, and reconfigure radio bearers of target master node to be radio bearers of target secondary node; or
activating radio resource control (RRC) re-establishment to cause the user device to establish a new connection with a master network node.

25-34. (canceled)

35. An apparatus comprising:
at least one processor; and
at least one memory including computer program code;
the at least one memory and the computer program code configured to, with the at least one processor, cause the apparatus at least to:
receive, by a second network node configured as a secondary node from a first network node configured as a master node as part of a dual connectivity for a user device, information requesting the second network node to prepare resources including at least a partially activated signaling radio bearer to enable the user device to communicate a radio link failure report to report a failure of a first random access procedure between the user device and the first network node via the partially activated signaling radio bearer and a second random access procedure of the user device with the second network node, regardless of whether a connection has been established between the user device and the first network node;
partially activate, by the second network node, a signaling radio bearer to receive a radio link failure report via the second random access procedure with the user device, regardless of whether a connection has been established between the user device and the first network node;
transmit, by the second network node to be delivered to the user device, preconfiguration information including at least the signaling radio bearer configuration for the partially activated signaling radio bearer; and
receive, by the second network node from the user device, via the partially activated signaling radio bearer, a radio link failure report indicating the failure of the first random access procedure with the first network node.

36. The apparatus of claim 35, wherein the at least one processor and the computer program code configured to transmit preconfiguration information comprises the at least one processor and the computer program code configured to cause the apparatus to:
transmit, by the second network node to be delivered to the user device, preconfiguration information including at least the signaling radio bearer configuration for the partially activated signaling radio bearer, and information identifying a random access preamble to be used by the user device as part of the second random access procedure between the user device and the second network node.

37. The apparatus of claim 35, wherein the at least one processor and the computer program code are configured to further cause the apparatus to:
transmit, by the second network node to the first network node, the radio link failure report received from the user device;
receive, by the second network node from the first network node a message indicating the action to be performed by the user equipment after the failure of the first random access procedure for the user device with the first network node; and
transmit, by the second network node to the user device, a message indicating an action to be performed by the user device in response to the failure of the first random access procedure with the first network node.

38. The apparatus of claim 35, wherein the first network node comprises a target master node, and the second network node comprises a target secondary node, wherein a handover of the user device to the target master node has failed or a connection establishment or a random access procedure of the user device to the target master node has failed.

39. The apparatus of claim 35, wherein the preconfiguration information comprises a signaling radio bearer configuration for a partially activated signaling radio bearer 3 (SRB3) or split-SRB1, which has been activated for the second network node to accept a random access procedure Msg3 from the user device that includes the radio link failure report, without activating a data radio bearer (DRB) for the second network node.

40. The apparatus of claim 35, wherein the radio link failure report comprises at least one of:
a flag indicating the failure of the first random access procedure with the first network node;
a measurement report including latest measurements performed by the user device with respect to one or more neighbor cells or network nodes;
a suggested or preferred action to be performed in response to the failure of the first random access procedure with the first network node.

41. The apparatus of claim 35, wherein the preconfiguration information comprises one or more of:
information indicating time-frequency resources to be used by the user device for random access procedure message transmission to the second network node;
information indicating a random access preamble to be used by the user device for transmission of a Msg1 or random access preamble of a contention-free random access procedure with the second network node; or
information indicating a partially activated signaling radio bearer that has been partially activated to enable the user device to transmit, via the second random access procedure to the second network node, a radio link failure report indicating the failure of the first random access procedure with the first network node, wherein the signaling radio bearer may be used to transmit the radio link failure report even though no connection has been established between the user device and the first network node.

42. The apparatus of claim 35, wherein the at least one processor and the computer program code configured to receive, by the second network node from the user device, via the partially activated signaling radio bearer, a radio link failure report comprises the at least one processor and the computer program code configured to:
receive, by the second network node from the user device, via a random access procedure Msg3 of the second random access procedure and via the partially activated signaling radio bearer, a radio link failure report.

43. The apparatus of claim 35, wherein the at least one processor and the computer program code configured to receive, by the second network node from the user device, via the partially activated signaling radio bearer, a radio link failure report comprises the at least one processor and the computer program code configured to:
receive, by the second network node from the user device via Msg3 of the second random access procedure and the signaling radio bearer, a buffer status report;
transmit, by the second network node to the user device from based on the buffer status report, an uplink grant indicating granted resources; and
receiving, the second network node from the user device via the granted resources and the signaling radio bearer, the radio link failure report indicating the failure of the first random access procedure with the first network node.

44. The apparatus of claim 35, wherein the first network node comprises a target master node, and the second network node comprises a target secondary node, and wherein the action to be performed by the user device in response to the failure of the first random access procedure comprises at least one of the following:
requesting, by a network node, a measurement report from the user device;
reconfiguring the target secondary node as the master node for the user device, and releasing dual connectivity for the user device;
swapping the target secondary node with the target master node so as to promote the target secondary node to be a new master node for the user device and making the target master node to be a new secondary node for the user device, and suspending the new secondary node;
retain the target master node as suspended, and reconfigure radio bearers of target master node to be radio bearers of target secondary node; and
activating radio resource control (RRC) re-establishment to cause the user device to establish a new connection with a master network node.

45-46. (canceled)

47. An apparatus comprising:
at least one processor; and
at least one memory including computer program code;
the at least one memory and the computer program code configured to, with the at least one processor, cause the apparatus at least to:
transmit, by a first network node configured as a master node to a second network node configured as a secondary node as part of a dual connectivity for a user device, information requesting the second network node to prepare resources including at least a partially activated signaling radio bearer to enable the user device to communicate to the second network node a radio link failure report to report a failure of a first random access procedure between the user device and the first network node via the partially activated signaling radio bearer and a second random access procedure of the user device with the second network node, regardless of whether a connection has been established between the user device and the first network node;
receive, by the first network node from the second network node, a radio link failure report originating from the user device and indicating the failure of the first random access procedure between the user device and the first network node;
transmit, by the first network node to the second network node for forwarding to the user device, a message indicating an action to be performed by the user device in response to the failure of the first random access procedure with the first network node.

48. The apparatus of claim 47, wherein the first network node comprises a target master node, and the second network node comprises a target secondary node, and wherein the action to be performed by the user device in response to the failure of the first random access procedure comprises at least one of the following:
requesting, by a network node, a measurement report from the user device;
reconfiguring the target secondary node as the master node for the user device, and releasing dual connectivity for the user device;
swapping the target secondary node with the target master node so as to promote the target secondary node to be a new master node for the user device and making the target master node to be a new secondary node for the user device, and suspending the new secondary node;
retain the target master node as suspended, and reconfigure radio bearers of target master node to be radio bearers of target secondary node; and
activating radio resource control (RRC) re-establishment to cause the user device to establish a new connection with a master network node.

49. (canceled)
